(19) United States
(12) Patent Application Publication
(10) Pub. No.: US 2015/0266250 A1
(43) Pub. Date: Sep. 24, 2015

(54) APPARATUS AND METHOD TO MANUFACTURE SEMI-FINISHED PRODUCTS FOR WIND POWER INSTALLATION ROTOR BLADES AS WELL AS ROTOR BLADE AND WIND POWER INSTALLATIONS

(71) Applicant: WOBBEN PROPERTIES GMBH, Aurich (DE)

(72) Inventors: Alexander Hoffmann, Emden (DE); Peter Friede, Suedbrookmerland (DE); Jens Gebers, Ihlow (DE); Frank Knoop, Aurich (DE)

(21) Appl. No.: 14/441,490

(22) PCT Filed: Sep. 25, 2013
(86) PCT No.: PCT/EP2013/069938

§ 371 Date: May 7, 2015

(30) Foreign Application Priority Data
Nov. 8, 2012 (DE) 10 2012 021 802.8
Mar. 15, 2013 (DE) 10 2013 204 635.9

(51) Int. Cl. B29D 99/00; F03D 11/04; F03D 1/06; B29C 70/02

(52) U.S. Cl. CPC B29D 99/0028; B29C 70/021; F03D 11/04; F03D 1/0675; B29L 2031/08

(57) ABSTRACT

An apparatus to manufacture semi-finished blade end products for wind power installation rotor blades with a winding mandrel which can be rotated for rolling up preferably ribbon-like fiber composite materials.

An impregnating device, which can move along the winding mandrel to impregnate the fiber composite material before it is rolled up, preferably be a magazine device which moves synchronously with the impregnating device along the winding mandrel to provide the fiber composite material.

### BACKGROUND

1. Technical Field

The present invention relates to an apparatus to manufacture blade ends for wind power installation rotor blades, with a winding mandrel which can be rotated for rolling up preferably ribbon-like fiber composite materials.

2. Description of the Related Art

In principal, in the rotor blade technology field and in particular in the rotor blade technology field of wind power installations, special stability requirements are set regarding the end pieces on the side of the hub of rotor blades, since these are responsible for the force transmission from the blade into the hub and are exposed to especially high static as well as dynamic forces. Therefore, it is very important that the blade ends of rotor blades for wind power installations be manufactured with a high production precision and in compliance with high quality standards.

Blade ends for the above referenced rotor blades often consist of several components, at least some of which are made of fiber composite materials. The combination of several form parts made of fiber composite materials in dry form is known from prior art. So far, the thus combined “dry” fiber composite form parts are commonly sealed gas-tight against each other, evacuated and subsequently impregnated with a fluid in a so-called vacuum injection or infusion method (hereinafter referred to as “impregnating fluid”). After permeating the fiber composite material, the fluid hardens, giving the overall structure the characteristics of bonding and stability.

In this known method, which usually produces satisfying results, it can occur in certain individual cases, however, that the impregnating fluid does not permeate at the same speed in different structural areas of the form parts made of fiber composite material. By this forming of an irregular flow front, in extreme cases, it can happen that the fiber composite material is not moistened with impregnating fluid in the same way at all locations. The insufficiently moistened locations can result in a lower strength of the component in the hardened state, which increases the risk of failure.

Furthermore, in view of the economics of the production in the prior art, it is regarded as disadvantageous that, in order to produce such combinations of individual form parts, additional means have to be inserted or provided which make an evacuation and guiding of the impregnating fluid possible, such as vacuum film and fluid lines.

For example, a winding technology for rotor blades of a wind power installation to form the basic structure of a blade end is known from DE_{—}10_{—}2010_{—}026 018 A1. However, the disadvantages found in the prior art are not implemented herein.

### BRIEF SUMMARY

One embodiment is directed to an apparatus with which blade ends can be produced with slight deviations in strength. Furthermore, the embodiment may provide improved economics of production for an apparatus of the type described in the beginning

In the case of an apparatus of the type described in the beginning, one or more embodiments of the invention solves the underlying object by having a impregnating device which can move along the winding mandrel to impregnate the fiber composite material before it is rolled up around the winding mandrel, and, preferably, a magazine device which moves synchronously with the impregnating device along the winding mandrel to provide the fiber composite material.

At least one embodiment of the invention is based on the findings that a better overall impregnation of the fiber composite material can be achieved by an impregnating process. This impregnation process makes it unnecessary to integrate additional structural element, such as vacuum film or fluid lines, in addition to the fiber composite material for the blade end.

The impregnation device and the magazine device, which provides the fiber composite material, preferably move along the rotatable winding mandrel, so that the fiber composite material can be rolled onto the winding mandrel in a continuous process and is simultaneously, shortly before the rolling process, itself provided with impregnating fluid in the impregnating device. The roll-up shortly after the impregnating process achieves an extremely advantageous and even distribution of the impregnating fluid within the fiber composite material structure. A (synthetic) resin can, for example, be an impregnating fluid. CFK or GFK can, for example, be a fiber composite material, according to the invention.

The fact that the winding mandrel can rotate in a stationary position and that the construction units of the impregnating device and the magazine device, which are much smaller compared to the winding mandrel, move along the winding mandrel further provide an optimized structure with respect to the apparatus.

The magazine device has a plurality of rotatable mounted roll mounts to accept fiber composite material rolls. Preferably, of these fiber composite material rolls, one primary roll should be active to wrap fiber composite material, whereby the fiber composite material is pushed via the impregnating device of the apparatus to the winding mandrel and wrapped up on this by rotation of the winding mandrel. In the case of a necessary change of the roll, preferably a (secondary) roll is to be used in stand-by before the previous roll is rolled off completely, in order to be able to inject and unroll fiber composite material from the next roll into the transportation route with as little delay as possible.

The remaining non-active rolls serve as a supply of fiber composite material and ensure that exchange times for swapping rolls (which impact the exchange process) are as short as possible. By providing a magazine device of the type described above, new unconsumed fiber composite material rolls can be inserted in the location of the previously unrolled fiber composite material rolls without interrupting the apparatus and the wrapping process.

In a preferred embodiment of the present invention, the roll mounts have a motor drive. It is furthermore preferred that the winding mandrel also have a motor drive.

Particularly preferred are the motor drive of the roll mount and the motor drive of the winding mandrel, preferably via an electronic control unit which can be operated dependent on each other. Preferably, the driving forces and unroll speeds of the roll mounts are controlled in such a way that they ensure a constant path speed of the unwrapped fiber composite material, in spite of a progressively decreasing roll diameter. The same shall preferably apply to the winding mandrel, which maintains a constant path speed of the rolled up or respectively wrapped up fiber composite material, despite an increase in diameter of the gradually wrapped up fiber composite material layers.

Preferably, the electronic control unit or an additional electronic control unit is established to control the advance of the traverse movement of the impregnating device and the magazine device along the winding mandrel according to the specifications defined in advance.

Preferably, measuring equipment is provided for at the apparatus, which is developed to record the rolled off path speed at the magazine device and/or for the recording of the tape speed of the rolled up fiber composite material at the winding mandrel. This can, for example, be optical measuring equipment, which measures an increase or decrease in the thickness of the respective rolls. In combination with the readable rotating speed by the engine drive, the path speed can also be determined.

In another preferred embodiment of the invention, the magazine device has a revolver-like arrangement of the plurality of roll mounts. Due to the fact that the magazine device is designed as a revolver, the individual rolls can be brought into the respective operating position for roll off by rotating the magazine. Preferably, two neighboring rolls are active when a roll change is prepared. Preferably, in this process, the roll mount to be placed in operation next will pre-feed a certain amount of fiber composite material so that this can be advanced, if possible without a time delay, possibly overlapping the end section of the previous roll by the magazine device in the direction of the impregnating device.

Preferably, the revolver-like arrangement is rotationally mounted and, in particular, driven by an engine. The plurality of the roll mounts can, for example, be arranged on converging arms or a support ring.

The rotatability of the revolver-like arrangement also ensures that a roll change can be performed with an especially low amount of effort on the side opposite to the active rolls.

Pursuant to an especially preferred embodiment of the invention, the apparatus has a sewing machine which is preferably attached to the magazine device and not parallel to the roll-off direction, to connect a section, in particular an end section on the first fiber composite material roll, which is (preferably completely) rolled off from a first roll mount, to a section (preferably a starting section) of a second fiber composite material roll, which is (preferably not yet completely) rolled off from a second roll mount. Pursuant to this embodiment, during operation, the sewing machine sews the roll end of the used roll to the start of the not yet used roll so that the new roll is pulled by the end of the old roll through the winding process of the winding mandrel into the transportation route in the direction of the impregnating device. Furthermore, the use of the sewing machine enables the roll change to be performed without interruptions, a fact which has an especially advantageous effect on the economics of production. An industrial sewing machine, also called a bag sewing machine, can, for example, also be used as a sewing machine. A sufficiently large distance of the seam stitches ensures that the penetration with impregnating fluid is not improperly affected.

In additional preferred embodiments, instead or in addition to a sewing machine, a stapler device and/or a gluing device is provided to attach the sections of the fiber composite material.

Further preferred, in the case of an apparatus in a preferred embodiment, the impregnating device has a plurality of return pulleys to deflect the fiber composite material several times, which extends from the magazine device towards the winding mandrel. Preferably, the return pulleys are arranged in the same or different distance to the bottom of an impregnation basin. This bends the fiber composite material transported by the impregnating device several times in different directions. In each case, this results in an even more unified distribution of the impregnating fluid within the fiber composite material due to the reciprocal stretching and compressing away from the neutral fibers of the fiber composite material paths. Preferably, in operation, the impregnation basin is filled with fluid in such a way that the fiber composite material is dipped into the impregnating fluid several times.

Pursuant to another preferred embodiment of the invention, the impregnating device has a plurality of tension pulleys which can be brought into contact with the fiber composite material to stretch it, whereby preferably in each case, a tension pulley is arranged between two neighboring return pulleys. Preferably, the tension pulleys are designed to avoid the sagging or slipping of the fiber composite material in the impregnating device to ensure a cycle time of the fiber composite material through the impregnating device which is as uniform as possible. This will improve the uniformity of the order and variation in the degree of the saturation.

Preferably, several or all tension pulleys have measuring equipment to record the pulley tension. This can, for example, be force measuring equipment which records the downward force perpendicular to the path movement of the fiber composite materials. Preferably, this measuring equipment cooperates with the electronic control of the apparatus or a separate electronic control and signal outputs, if applicable.

Preferably, the impregnating device has a heating unit which is designed to hold the temperature of the impregnating fluid in a predefined value range. The temperature of the impregnating fluid affects the viscosity of the fluid, in particular if a resin or synthetic resin is selected, and is therefore preferably kept by the heating unit in a temperature area in which the viscosity enables a reliable and complete penetration of the fluid, which is, however, at the same time not so thin that the fluid simply flows through the fiber composite material without being stored by it to a sufficient degree.

Preferably, the winding mandrel of the apparatus is established to accept semi-finished products, preferably spar caps, which will be wrapped in fiber composite material. Spar caps are those inserts which attach on the inner wall of the winding mandrel and support or respectively strengthen the winding mandrel. It has also proven to be advantageous to use them in particular multi-piece winding mandrels, since the former can be arranged around the winding mandrel from both sides with a decreased logistical effort.

Furthermore, one or more embodiments of the invention relates to a method to produce blade ends for wind power installation rotor blades, in particular through an apparatus according to one of the above preferred exemplary embodiments. The method solves the objective formulated in the beginning in relation to the apparatus with the following steps: Provisions of fiber composite material on a magazine device, transport of the fiber composite material from the magazine device through an impregnating device to a winding mandrel, and rolling-up of the fiber composite material around the winding mandrel by rotating the winding mandrel, preferably driven by an engine, whereby the impregnating device and the magazine device move along the winding mandrel while rolling up.

The method uses the same findings and advantages as the apparatus; that is why we also refer in this regard to the above explanations. The operation of the apparatus or, respectively, the performance of the method in particular also shows that through a (preferably synchronous) method of the magazine device along the winding mandrel, an economic solution of the underlying objective is reached. Because, for example, the impregnating device can move with the magazine device along the winding mandrel, a much smaller impregnating device can be used than would be the case if the impregnating device were to remain stationary with the winding mandrel and only the magazine device were to move. Thus, a smaller volume of impregnating fluid would suffice to keep the fill level in the impregnating device at a sufficient level. Consequently, the energy and cost expenditures of heating the impregnating fluid are significantly lower compared to those of the stationary impregnating device. In addition, the fiber composite material is only moved through the impregnating device in the roll-off direction if it moves synchronously with the magazine device so that a “lateral flow” of the fiber composite material through the impregnating fluid is avoided. This enables an even more uniform impregnation on both sides of the fiber composite material path (i.e., left and right in relation to the roll-off direction).

Preferably, the method is further developed by providing the fiber composite material on a plurality of rotationally mounted roll mounts and the fact that the roll mounts rotate in such a way when transporting, preferably driven by an engine, that fiber composite material is rolled off.

Preferably, the winding mandrel and the roll mounts each have an engine drive and the roll mounts and the engine drive of the winding mandrel are operated dependent on one another, preferably through an electronic control unit, when implementing the method. Preferably, the drive is made in such a way that tension applied from the winding mandrel to the fiber composite material does not become too much and that, in addition, the roll-off and roll-up speeds, i.e., the path speeds of the fiber composite material on both ends of the transportation route, deviate as little as possible from each other. The path speed of the rolled-off or, respectively, rolled-up fiber composite material is preferably recorded through corresponding measuring equipment.

Further preferred, the method comprises the following steps: Connection of a section, in particular an end section of the first fiber composite material roll, which is (preferably completely) rolled off from a first roll mount, to a section (preferably a starting section) of a second fiber composite material roll, which is (preferably not yet completely) rolled off from a second roll mount. Preferably, the connection is made through a method, not parallel to the roll-off direction of the roll mount, with a sewing machine and sewing of the two sections to each other.

Further preferably, the method according to one embodiment of the invention comprises the step of several diversions of the fiber composite material which expands from the magazine device to the winding mandrel. The diversion preferably results through several return pulleys in the same [or] different distance to the bottom of an impregnation basin of the impregnating device.

Preferably, the stretching of the fiber composite material occurs between two neighboring return pulleys, in particular by bringing the fiber composite material in contact with a plurality of tension pulleys.

Moreover, the one or more embodiments of the invention relates to a method to produce a rotor blade for a wind power installation comprising a method according to one of the above described preferred exemplary embodiments and furthermore comprising the following steps:

Insertion of the wound fiber composite material into a form for curing,

Curing of the impregnating fluid after winding so that a cured fiber composite part is formed,

Removal of the winding mandrel from the cured fiber composite part

Preferably covering of the cured fiber composite part with one or several additional laminate layers so that a blade end is formed,

Connecting of the blade end after curing with one or several attachment parts, such as rear edge segments, blade tips, etc., in particular through screwing or gluing, to a rotor blade.

Preferably, the winding mandrel is removed after the curing of the impregnating fluid. Further preferably, the cured fiber composite part, also called the winding body, is inserted as a semi-finished product in a rotor blade form in which additional rotor blade parts are added after the winding mandrel is removed.

One or more embodiments of the invention further concerns a wind power installation with a tower, a nacelle which is mounted such that it can swivel on the tower, a rotor which is mounted such that it can swivel on the nacelle, and a plurality of rotor blades mounted on the rotor, of which at least one, preferably several or all, were or are produced according to the above described method for the production of a rotor blade for a wind power installation.

### BRIEF DESCRIPTION OF THE SEVERAL VIEWS OF THE DRAWINGS

The invention is described in more detail below by means of an exemplary embodiment, with reference to the accompanying figures. Here, the following show:

FIG. 1 a schematic cross-section pursuant to the preferred exemplary embodiment.

FIG. 2 a schematic cross-section of a blade end manufactured with the apparatus according to the invention pursuant to FIG. 1,

FIG. 3 a schematic cross-section of a rotor blade with a blade end pursuant to the preferred exemplary embodiment,

FIG. 4 a spatial presentation of a part of the apparatus pursuant to FIG. 1,

FIG. 5 a spatial presentation of the part of the apparatus pursuant to FIG. 4 in another orientation,

FIG. 6 a wind power installation with a rotor blade pursuant to the present invention.

### DETAILED DESCRIPTION

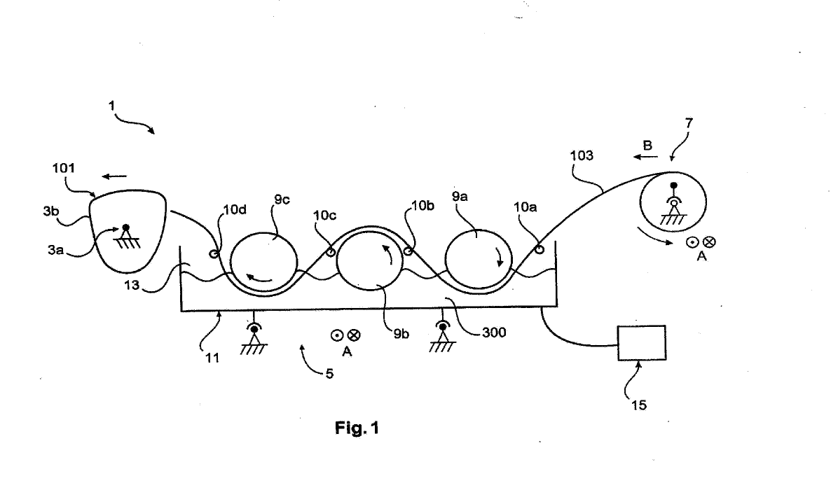

FIG. 1 shows a schematic display of the apparatus to produce a blade end pursuant to the preferred exemplary embodiment of the invention. The apparatus 1 has a winding mandrel 3a, which can be driven by a rotor. A winding housing 3b, around which a composite material 103 is wound in paths, is mounted on the winding mandrel 3a. The winding mandrel 3a is arranged stationary or fixed.

Furthermore, the apparatus 1 has an impregnating device 5. The impregnating device 5 has an impregnating basin 13 with a bottom 11. Several return pulleys 9a, 9b, 9c are arranged in the impregnating device 5 spaced from the bottom. The distance of the return pulleys 9a-9c to the bottom 11 can be selected as equal to each other, as schematically shown in FIG. 1, or different from each other, depending on which wrap angle of the fiber composite material 103 is desired around the return pulleys 9a, 9b, 9c. Furthermore, the impregnating device 5 has a plurality of tension pulleys 10a, 10b, 10c, 10d, which impact in a manner non-parallel to the travel direction of the fiber composite material 103 by contacting to increase or decrease the tension force in the direction of the return pulleys. This can also influence the wrap angle. In the exemplary embodiment shown in FIG. 1, the tension pulleys 10a, 10b cause a stretching of the fiber composite material 103 in the direction of the return pulley 9a, while the tension pulleys 10c, 10d cause a stretching of the fiber composite material 103 in the direction of the return pulley 9c. Alternative designs could also provide for tension pulleys 10b, 10c, which stretch the fiber composite material 103 in the direction of the return pulley 9b.

The impregnating device 5 is filled with an impregnating fluid 300 up to a predetermined level. The level of the impregnating fluid 300 is preferably selected in such a way that the fiber composite material 103 is dipped into the impregnating fluid 300 several times when being transported through the impregnating device 5. This is preferably ensured by lifting the fiber composite material 103 with the return pulley 9b from the fluid and dipping it into the fluid with the return pulleys 9a, 9c.

Furthermore, the impregnating device 5 can be heated by means of a control 15 in connection with (not displayed) heating agents in such a way that the impregnating fluid 300 provided for in the impregnating device 5 is kept at a pre-determined temperature range.

The impregnating device 5 can move in the direction of the arrow A, i.e., in FIG. 1 into the observation plane or out of it, preferably on busbars.

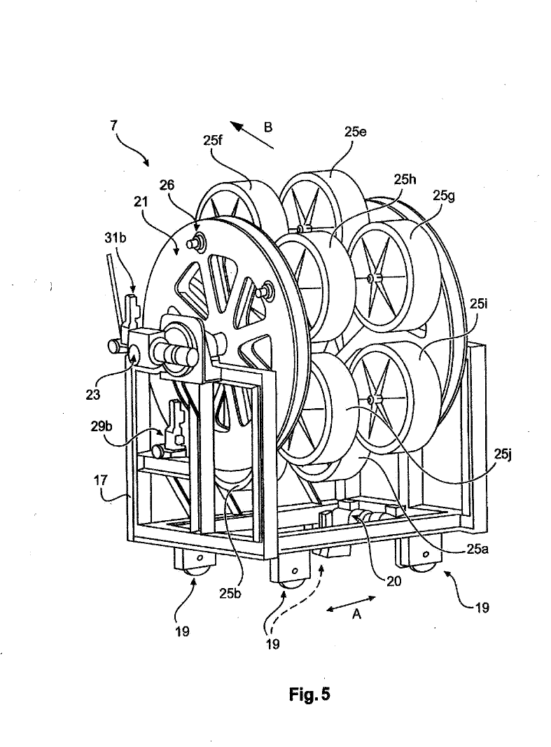

Furthermore, the apparatus 1 according to FIG. 1 has a magazine device 7. FIG. 1 shows the magazine device 7 only schematically as an individual roll. In regard to a more detailed, preferred embodiment of the magazine device 7, we refer to FIGS. 4 and 5. The magazine device 7 provides the fiber composite material 3. The fiber composite material is rolled off by the magazine device 7 in the direction of the arrow B. The magazine device 7 is movable, preferably synchronous with the impregnating device 5, in the direction of the arrow A, preferably on busbars.

During the operation of apparatus 1, fiber composite material is rolled off by the magazine device 7 in the direction of the arrow B and fed into the impregnating device 5. In the impregnating device 5, stretched by the tension pulleys 10a-10d, the fiber composite material 103 is conveyed to the return pulleys 9a-9c, where the fiber composite material 103 is dipped several times into the impregnating fluid 300, namely in each case between the return pulley 9a, 9c and the bottom 11 of the impregnating basin 13.

After traversing the impregnating device 5, the fiber composite material 103 is rolled up onto the rotating winding housing 3b, which rotates around the rotation axis of the winding mandrel 3a, whereby structure of a blade end 101 is provided on the winding housing 3b.

After the completed process of rolling up around the winding housing 3b, the (at first) still liquid impregnating fluid 300 is cured. After removing the winding housing 3b, the blade end 101 is complete.

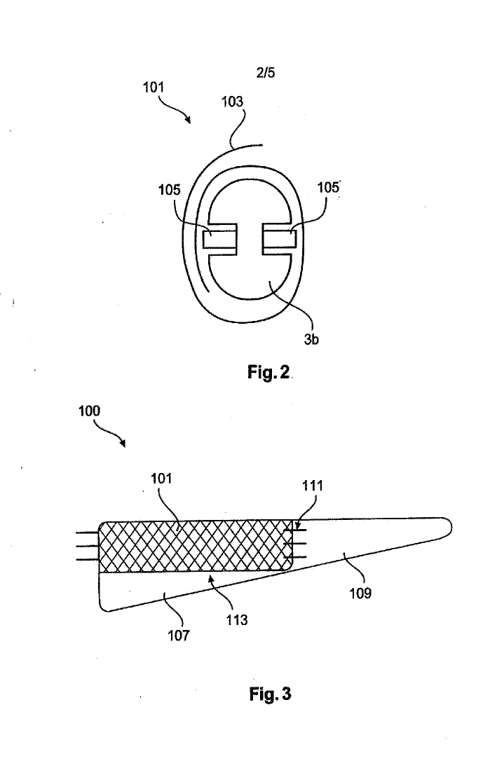

FIG. 2 illustrates the structure of the blade end 101, and thus also schematically the winding process, in a cross-section. The winding housing 3b pursuant to FIG. 2 is established to accept the fiber composite material 103 and also in addition to accept semi-finished products pursuant to FIG. 2 in the form of spar caps 105. The fiber composite material 103 is wrapped around the spar caps 105 together with the winding housing 3b. The spar caps 105 are preferably pre-impregnated with impregnating fluid.

The winding housing 3b, shown in FIG. 2 as one piece, can alternatively also be designed in several pieces, which facilitates mounting it on the winding mandrel 3a (FIG. 1). In operation of apparatus 1 pursuant to FIG. 1, the number (one or several) of required semi-finished products, for example the spar caps 105, is preferably first installed on the winding housing 3b. Subsequently, fiber composite material 103 is rolled onto the winding housing 3b by way of operation of the apparatus 1. This makes it possible to apply the desired number of layers onto the winding housing 3b through a variation of the advance of the impregnating device 5 and the magazine device 7 relative to the winding mandrel 3a and the winding housing 3b, until the desired structure is generated.

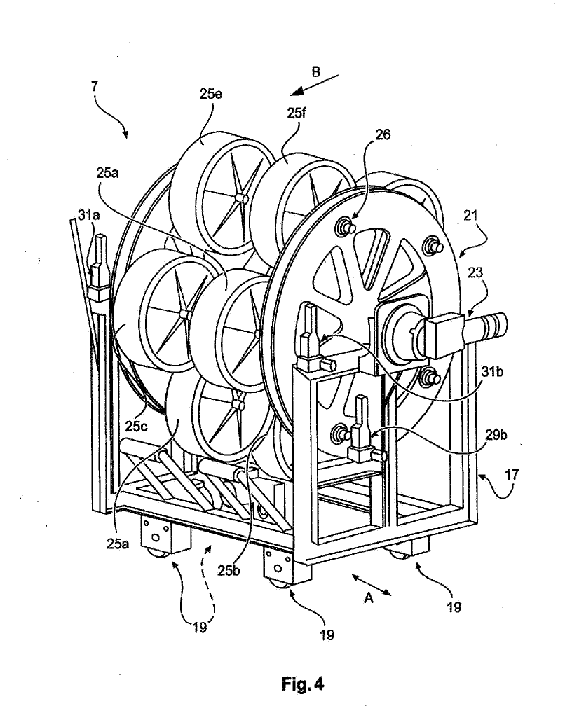

Subsequent to this process and also subsequent to the curing and other completion of the blade end 101, the blade end is combined with other components to a rotor blade, as is schematically displayed in FIG. 3. Pursuant to FIG. 3, on the side of the hub, the rotor blade 100 has the blade end 101.

After curing, the blade end as a fiber composite part is essentially already the outside contour of the rotor blades. Additional fiber composite material layers can be applied to perfect the form: for example, to form the rear edge segment.

Preferably by gluing, the blade end 101 is connected at the interface 113 with a rear edge segment 107. Furthermore, the blade end 101 is connected on the side opposite the hub with a blade tip 109, preferably by screwing, indicated by reference number 111.

The magazine device 7, shown schematically as an individual roll in FIG. 1, is shown in more detail in FIGS. 4 and 5. The magazine device 7 has a frame 17. The frame can be moved be means of several rolls 19 (in the direction of arrow A), preferably on busbars. The rolls 19 are at least in part driven by an engine. A wheel 21 is mounted (such that it can swivel) on both sides of the frame 17. The wheels 21 are coupled by a common axis. Furthermore, the wheels 21 can be moved by means of a motor drive 23.

In a revolver-like arrangement, the plurality of roll mounts 25a-25j are mounted (such that they can rotate) on the wheels 21. The roll mounts 25a-25j each have a coupler 26 (only one has a reference number). The coupler 26 can be coupled with a motor drive 29b, 31a, 31b, which is in each case arranged on the frame 17. Roll mounts 25 are established to carry fiber composite material rolls. For this purpose, dependent on the dimensions of the fiber composite material rolls, the roll mounts can either each carry one roll or each a pair, whereby opposing pairs on the respective other wheel 21 then each accept an end segment of the corresponding fiber composite material roll. The roll mounts 25e-25j, which, in the orientation shown in FIGS. 4 and 5, are specifically not coupled with a motor drive 29, 31, make possible a change of the fiber composite material roll even during operation of the motor drives 29, 31 to roll off fiber composite material from the roll mounts 25a-25d.

If a roll is rolled off during operation, decoupling of the empty roll from the drive motor, rotating of the magazine device, and coupling of the next roll can ensure a quasi-continuous operation.

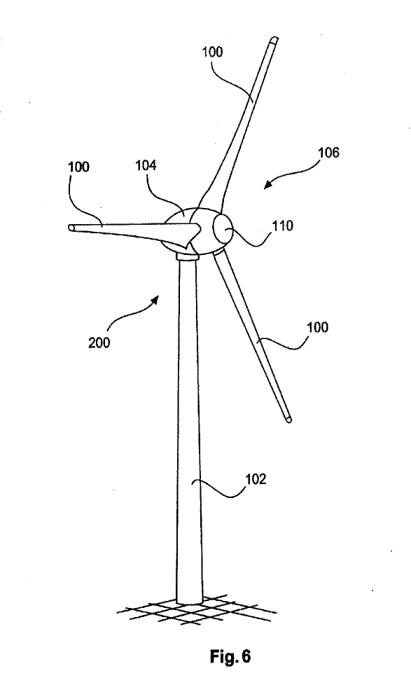

FIG. 6 shows a wind power installation 200 with a tower 102 and a nacelle 104. A rotor 106 with three rotor blades 100 according to the preferred exemplary embodiment and a spinner 110 is located on the nacelle 104. The rotor 106 is set in operation by the wind in a rotating movement and thereby drives a generator in the nacelle 104.

1. An apparatus to produce semi-finished blade end products for wind power installation rotor blades, the apparatus comprising:
a magazine device configured to provide a fiber composite material;
impregnating device that receives the fiber composite material from the magazine device and impregnates fluid into the fiber composite material; and
a winding mandrel configured to rotate and roll up the fiber composite material received from the impregnating device to form a semi-finished blade end product.

2. The apparatus according to claim 1 wherein the magazine device has a plurality of rotatably mounted roll mounts configured to receive fiber composite material rolls.

3. The apparatus according to claim 2, wherein the roll mounts are driven by a motor.

4. The apparatus according to claim 3 wherein the winding mandrel is driven by a motor, wherein the motor of the roll mounts and the motor of the winding mandrel are coupled to an electronic control unit and configured to be operated dependent on each other by the electronic control unit.

5. The apparatus according to claim 2 wherein the roll mounts are mounted on the magazine device in a revolver-like arrangement.

6. The apparatus according to claim 5, wherein the revolver-like arrangement is rotationally mounted.

7. The apparatus according to claim 1, further comprising a sewing machine located after the magazine device configured to receive and connect a an end section of a first fiber composite material roll that is rolled off from a first roll mount to a section of a second fiber composite material roll that is rolled off from a second roll mount.

8. The apparatus according to claim 1 wherein the impregnating device has a plurality of return pulleys for moving the fiber composite material received from the magazine device and provided to the winding mandrel.

9. The apparatus according to claim 8 wherein the impregnating device has a plurality of tension pulleys configured to be placed in contact with the fiber composite material and to place the fiber composite material in tension, wherein at least one tension pulley is arranged between two neighboring return pulleys.

10. The apparatus according to claim 1 wherein the winding mandrel is configured to accept a semi-finished product, and the composite material is wound around the semi-finished product.

11. A method to produce blade ends for wind power installation rotor blades, the method comprising:
providing a fiber composite material using a magazine device,
transporting the fiber composite material from the magazine device through an impregnating device to a winding mandrel, and
winding up of the fiber composite material around the winding mandrel by rotating the mandrel, wherein the impregnating device and the magazine device move synchronously to one another along the winding mandrel.

12. The method according to claim 11, wherein the fiber composite material is provided on a plurality of rotatably mounted roll mounts, and the roll mounts rotate in such a way that the fiber composite material rolls off the roll mounts.

13. The method according to claim 12, wherein the winding mandrel and the roll mounts are driven by a motor, respectively, and motors are operated dependent on one another by an electronic control unit.

14. The method according to claim 11 comprising connecting a section of an end section of the first fiber composite material roll from a first roll mount to a section of a second fiber composite material roll from a second roll mount.

15. The method according to claim 11 comprising tensioning the fiber composite material to cause the fiber composite material to expand while traveling from the magazine device to the winding mandrel.

16. The method according to claim 11 further comprising:
inserting the wound fiber composite material into a form for curing,
curing the impregnating fluid after winding so that a cured fiber composite part is formed,
removing the winding mandrel from the cured fiber composite part
covering the cured fiber composite part with one or more laminate layers so that a blade end is formed, and
connecting the blade end with one or more attachment parts to a rotor blade.

17. A power installation comprising:
a tower,
a nacelle mounted on the tower,
a rotor that is rotatable mounted to the nacelle, and
a plurality of rotor blades mounted on the rotor, wherein one of the rotor blades was produced by a method that includes:
providing a fiber composite material using a magazine device,
transporting the fiber composite material from the magazine device through an impregnating device that includes impregnating fluid to a winding mandrel,
winding up of the fiber composite material around the winding mandrel by rotating the mandrel, wherein the impregnating device and the magazine device move synchronously to one another,
curing the would fiber composite material and impregnating fluid after winding to form a cured fiber composite part,
removing the winding mandrel from the cured fiber composite part,
covering the cured fiber composite part with one or more laminate layers so that a blade end is formed, and
connecting the blade end with one or more attachment parts to a rotor blade.
